(19) United States
(12) Patent Application Publication
(10) Pub. No.: US 2003/0139881 A1
(43) Pub. Date: Jul. 24, 2003

(54) Method and apparatus for activating a crash countermeasure

(75) Inventors: Ronald Hugh Miller, Saline, MI (US); Irving Toivo Salmeen, Ann Arbor, MI (US)

Correspondence Address: KEVIN G. MIERZWA, ARTZ & ARTZ, P.C., 28333 TELEGRAPH ROAD, SUITE 250, SOUTHFIELD, MI, 48034, US

(73) Assignee: Ford Global Technologies, Inc., Dearborn, MI (US)

(21) Appl. No.: 09/683,602

(22) Filed: Jan. 24, 2002

(51) Int. Cl. G08G 1/16; G06G 7/78

(52) U.S. Cl. 701/301; 342/455; 340/903; 340/436

(57) ABSTRACT

A system is provided (10) for sensing a potential collision of a first vehicle (11) with a second vehicle (72) that transmits a second vehicle information signal. The pre-crash sensing system (10) includes a threat registry (17), a position sensor (18) generating a first position signal corresponding to a position of the first vehicle, and a first sensor (20) generating sensor signals from the first vehicle. The vehicle also includes a receiver (22) that receives the second vehicle position signal from the second vehicle and a countermeasure system (40). A controller (12), (13) is coupled to the threat registry, the position sensor, the first sensor, the receiver, and the countermeasure system. The controller determines a time to collision and a distance to collision in response to the second vehicle information, the first position signal and the second vehicle position. The controller determines a threat level as a function of the time to collision and the distance to collision, activating the countermeasure system in response to the threat level and storing the vehicle threat level in the threat registry.

### BACKGROUND OF INVENTION

The present invention relates to pre-crash sensing systems for automotive vehicles, and more particularly, to side impact pre-crash sensing systems having counter-measures operated in response to pre-crash detection.

Auto manufacturers are investigating radar, lidar, and vision-based pre-crash sensing systems to improve occupant safety. Current vehicles typically employ accelerometers that measure forces acting on the vehicle body. In response to accelerometers, airbags or other safety devices are employed. Also, Global Position Systems (GPS) systems are used in vehicles as part of navigation systems.

In certain crash situations, it would be desirable to provide information to the vehicle operator before forces actually act upon the vehicle. As mentioned above, known systems employ combinations of radar, lidar and vision systems to detect the presence of an object in front of the vehicle a predetermined time before an actual crash occurs.

Other systems broadcast their positions to other vehicles where the positions are displayed to the vehicle operator. The drawback to this system is that the driver is merely warned of the presence of a nearby vehicle without intervention. In a crowded traffic situation, enormous amounts of data may be exchanged. Further, such systems may have a CPU that is simultaneously updating information and forming calculations for all vehicles. It would therefore be desirable for vehicle that pose a threat to each other to communicate rather than all vehicles within a desired distance.

It would be desirable to provide a system that takes into consideration the threat level of the vehicle in allocating resources.

### SUMMARY OF INVENTION

The present invention provides an improved system that deploys a countermeasure in response to the position the object detected.

In one aspect of the invention, a method for operating a pre-crash sensing system for a first vehicle proximate a second vehicle a counter-measure system comprising: generating an object detection signal over a field of view from a first vehicle; receiving the object detection signal at the second vehicle when positioned within the field of view; generating a response signal in response to said high frequency signal, said response signal including a key; establishing an communication link between said first vehicle and said second vehicle using said key; communicating a first vehicle data signal to the second vehicle using said key; and communicating a second vehicle data signal to the second vehicle using said key.

In a further aspect of the invention, a system is provided for sensing a potential collision of a first vehicle with a second vehicle that transmits a second vehicle information signal. The pre-crash sensing system includes a threat registry, a position sensor generating a first position signal corresponding to a position of the first vehicle, and a first sensor generating sensor signals from the first vehicle. The vehicle also includes a receiver that receives the second vehicle position signal from the second vehicle and a countermeasure system. A controller is coupled to the threat registry, the position sensor, the first sensor, the receiver, and the countermeasure system. The controller determines a time to collision and a distance to collision in response to the second vehicle information, the first position signal and the second vehicle position. The controller determines a threat level as a function of the time to collision and the distance to collision, activating the countermeasure system in response to the threat level and storing the vehicle and threat level in the threat registry.

One advantage of the invention is that by exchanging communication keys, the number of vehicles communicated with are limited and thus more processing resources can be devoted to processing desired vehicles.

Other aspects and features of the present invention will become apparent when viewed in light of the detailed description of the preferred embodiment when taken in conjunction with the attached drawings and appended claims.

### BRIEF DESCRIPTION OF DRAWINGS

FIG. 1 is a block diagrammatic view of a pre-crash sensing system according to the present invention.

FIG. 2 is a plan view of a vehicle network according to the present invention.

FIG. 3 is a perspective view of an automotive vehicle instrument panel display for use with the present invention.

FIG. 4 is a front view of a vehicle network display according to the present invention.

FIG. 5 is a front view of a warning display according to the present invention.

FIG. 6 is a counter-measure display according to the present invention.

FIG. 7 is a plan view of three vehicles relative to each other on a road forming a network therebetween.

FIG. 8 is a plan view of one embodiment of a threat registry according to the present invention.

FIG. 9 is a flow chart of the operation of a pre-crash sensing system according to the present invention.

FIG. 10 is a flow chart of the operation of exchanging vehicle information according to one aspect of the invention.

### DETAILED DESCRIPTION

In the following figures the same reference numerals will be used to identify the same components in the various views.

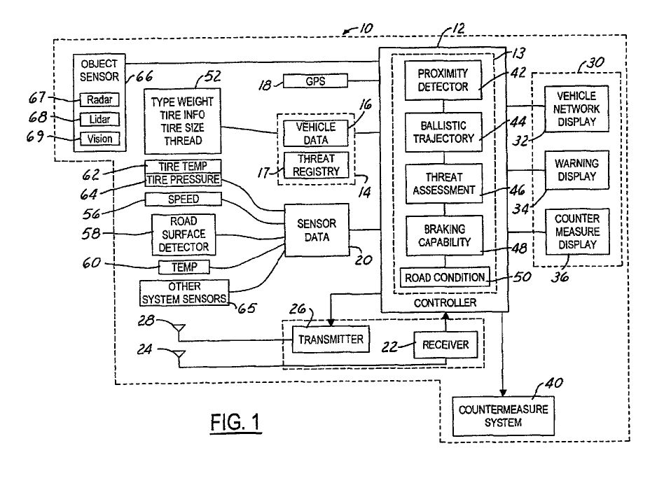

Referring now to FIG. 1, a pre-crash sensing system 10 for an automotive vehicle 11 has a controller 12. Controller 12 is preferably a microprocessor-based controller that is coupled to a memory 14. Controller 12 has a CPU 13 that is programmed to perform various tasks. CPU 13 has various resources such as clock cycles to allocate to the sensing system.

Memory 14 is illustrated as a separate component from that of controller 12. However, those skilled in the art will recognize that memory may be incorporated into controller 12. Memory 14 may comprise various types of memory including read only memory, random access memory, electrically erasable programmable read only memory, and keep alive memory. Memory 14 is used to store various thresholds and parameters including vehicle data 16 and a threat registry 17 as illustrated.

Controller 12 is coupled to a global positioning system 18 that receives position data triangulated from satellites as is known to those skilled in the art.

Controller 12 is coupled to a sensor data block 20 that represents various sensors located throughout the vehicle. The various sensors will be further described below.

Controller 12 may also be coupled to a receiver 22 coupled to a receiving antenna 24 and a transmitter 26 coupled to a transmitting antenna 28.

Controller 12 is also coupled to a display 30 that may include various types of displays including a vehicle network display, a warning display 34, and a countermeasure display 36. Each of these displays will be described in further detail below. As should be noted, display 30 may be a single display with different display features or may be individual displays that may include audible warnings as well.

Controller 12 has various functional blocks illustrated within CPU 13. Although these functional blocks may be represented in software, they may also be illustrated in hardware. As will be further described below, controller 12 has a proximity detector 42 that is used to determine the proximity of the various vehicles around automotive vehicle 11. A vehicle trajectory block 44 is used to determine the trajectory of the vehicle and surrounding vehicles. Based upon the vehicle trajectory block 44, a threat assessment is made in functional block 46. Of course, threat assessment 46 takes into consideration various vehicle data 16 and sensor data from sensor block 20. Threat assessment 46 may be made based upon the braking capability of the present vehicle and surrounding vehicles in block 48 and also road conditions of the present vehicle and surrounding vehicles in block 50. As will be further described below, the road conditions of block 50 may be used to determine the braking capability in block 48.

In block 16, various vehicle data are stored within the memory. Vehicle data represents data that does not change rapidly during operation and thus can be fixed into memory. Various information may change only infrequently and thus may also be fixed into memory 14. Vehicle data includes but is not limited to the vehicle type, which may be determined from the vehicle identification number, the weight of the vehicle and various types of tire information. Tire information may include the tire and type of tread. Such data may be loaded initially during vehicle build and may then manually be updated by a service technician should information such as the tire information change.

Global positioning system (GPS) 18 generates a position signal for the vehicle 11. Global positioning system 18 updates its position at a predetermined interval. Typical interval update periods may, for example, be one second. Although this interval may seem long compared to a crash event, the vehicle position may be determined based upon the last up update from the GPS and velocity and acceleration information measured within the vehicle.

Sensor data 20 may be coupled to various sensors used in various systems within vehicle 11. Sensor data 20 may include a speed sensor 56 that determines the speed of the vehicle. Speed sensor may for example be a speed sensor used in an anti-lock brake system. Such sensors are typically comprised of a toothed wheel from which the speed of each wheel can be determined. The speed of each wheel is then averaged to determine the vehicle speed. Of course, those skilled in the art will recognize that the vehicle acceleration can be determined directly from the change in speed of the vehicle. A road surface detector 58 may also be used as part of sensor data 20. Road surface detector 58 may be a millimeter radar that is used to measure the road condition. Road surface detector 58 may also be a detector that uses information from an anti-lock brake system or control system. For example, slight accelerations of the wheel due to slippage may be used to determine the road condition. For example, road conditions such as black ice, snow, slippery, or wet surfaces may be determined. By averaging microaccelerations of each tire combined with information such as exterior temperature through temperature sensor 60, slippage can be determined and therefore the road conditions may be inferred therefrom. Such information may be displayed to the driver of the vehicle. The surface conditions may also be transmitted to other vehicles.

Vehicle data 16 has a block 52 coupled thereto representing the information stores therein. Examples of vehicle data include the type, weight, tire information, tire size and tread. Of course, other information may be stored therein.

Sensor data 20 may also include a tire temperature sensor 62 and a tire pressure sensor 64. The road condition and the braking capability of the vehicle may be determined therefrom.

Other system sensors 65 may generate sensor data 20 including steering wheel angle sensor, lateral acceleration sensor, longitudinal acceleration sensor, gyroscopic sensors and other types of sensors.

An object sensor 66 is coupled to controller 12. Object sensor 66 generates an object signal in the presence of an object within the line of sight. Object sensor 66 may be comprised of one or a number of types of sensors including a radar 67, a lidar 68, and a vision system 69. Vision system 69 may be comprised of one or more cameras or CCD type devices. Both radar 67 and lidar 68 are capable of sensing the presence and the distance of an object from the vehicle. Vision system 69 may also be comprised of a stereo pair of cameras. When used as a stereo pair, the cameras act together and are capable of detecting the distance of an object from the vehicle. As will be further described below, radar 67 or lidar 68 may be used to detect an object within a detection zone or field of view and vision system 69 may be used to provide the size of the object to controller 12. When a radar 67 is used together with vision system 69, only one camera need be used rather than the stereo pair. In another embodiment of the invention the stereo pair may use a well known triangulation techniques to determine the presence of an object and the distance from the vehicle as well as the object size which may include area, height or width, or combinations thereof.

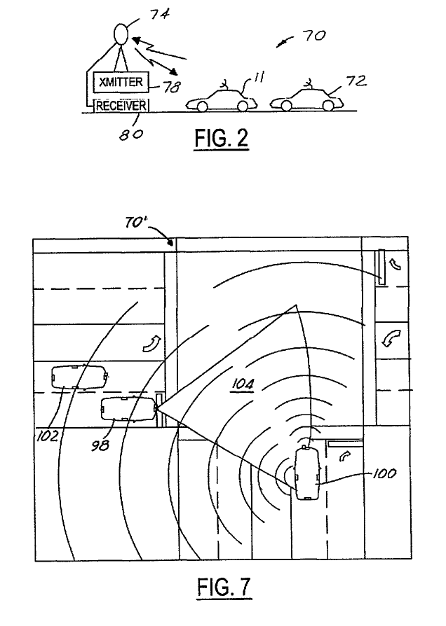

Referring now to FIG. 2, vehicle 11 may be part of a network 70 in conjunction with a second vehicle or various numbers of vehicles represented by reference numeral 72. Vehicle 72 preferably is configured in a similar manner to that of vehicle 11. Vehicle 72 may communicate directly with vehicle 11 through transmitter 26 and receiver 22 to form a wireless local area network. The network 70 may also include a repeater 74 through which vehicle 11 and vehicle 72 may communicate. Repeater 74 has an antenna 76 coupled to a transmitter 78 and a receiver 80. Various information can be communicated through network 70. For example, vehicle data, position data, and sensor data may all be transmitted to other vehicles throughout network 70.

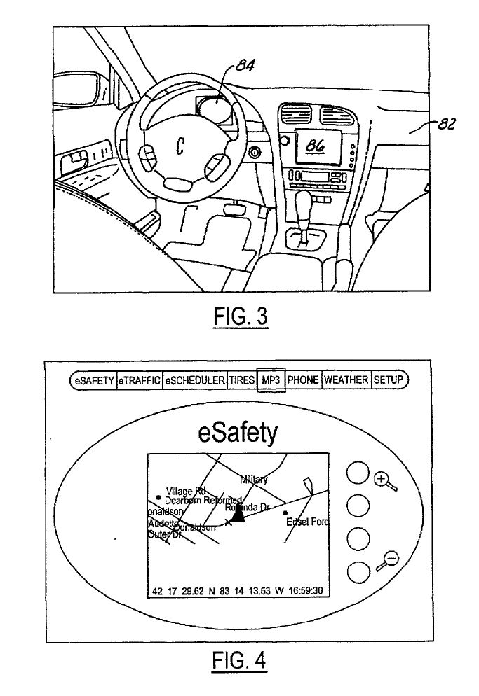

Referring now to FIG. 3, an instrument panel 82 is illustrated having a first display 84 and a second display 86. Either displays 84, 86 may be used generate various information related to the pre-crash sensing system.

Referring now to FIG. 4, display 84 is illustrated in further detail. Display 84 corresponds to the vehicle network display 32 mentioned above. The vehicle network display 32 may include a map 88, a first vehicle indicator 90, and a second vehicle indicator 92. First vehicle indicator corresponds to the vehicle in which the pre-crash sensing system is while vehicle indicator 92 corresponds to an approaching vehicle. Vehicle network display 32 may be displayed when a vehicle is near but beyond a certain distance or threat level.

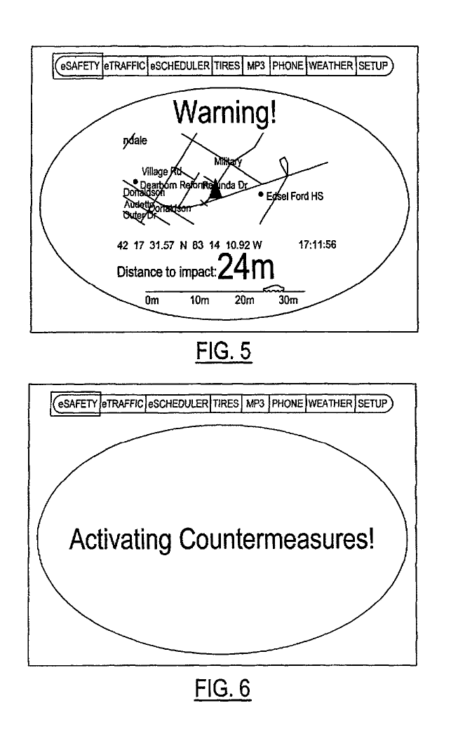

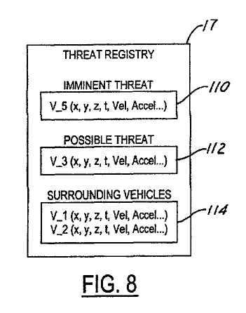

Referring now to FIG. 5, display 84 showing a warning display 34 is illustrated. Warning display 34 in addition to the display information shown in vehicle network display in FIG. 3, includes a warning indicator 94 and a distance indicator 96. Distance indicator 96 provides the vehicle operator with an indication of the distance from a vehicle. The warning display 34 may be indicated when the vehicle is within a predetermined distance or threat level more urgent than that of vehicle network display 32 of FIG. 3.

Referring now to FIG. 6, vehicle display 84 changes to a counter-measure display 36 to indicate to the vehicle operator that a counter-measure is being activated because the threat level is high or the distance from the vehicle is within a predetermined distance less than the distances needed for activation of displays shown in FIGS. 3 and 4.

Referring now to FIG. 7, a network 70″ may be formed between a first vehicle 98, a second vehicle 100 and a third vehicle 102. First vehicle 98 and third vehicle 102 are adjacent to each other and may communicate various information therebetween. As is illustrated the first vehicle has a field of view 104 from an object sensor. The first vehicle obstructs the view of the third vehicle relative to the second vehicle 100. Therefore, it would be desirable for the first vehicle 98 and the third vehicle 102 to share information such as the threat registry that may include information about the position and other information about the second vehicle 100.

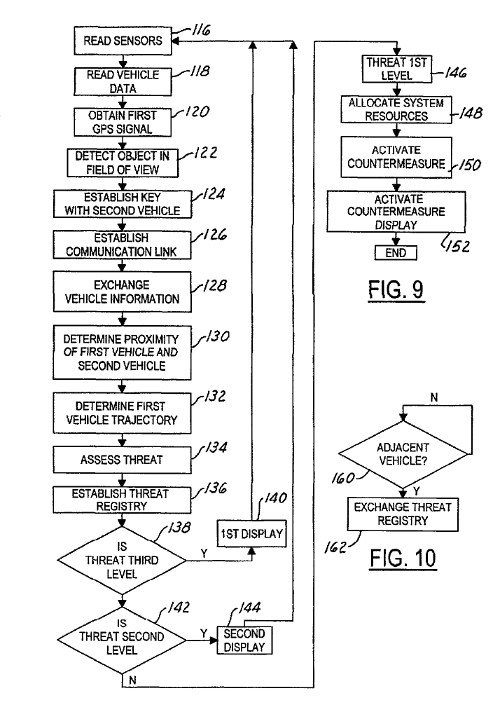

Referring now to FIG. 9, threat registry 17 is illustrated in further detail. In the example illustrated, threat registry 17 is divided into three portions. The first portion is an imminent threat portion 110. Imminent threat portion has vehicles that pose an imminent threat based upon various operating conditions, including the position, velocity and acceleration of the target vehicle relative to the monitoring vehicle. The time to impact and the distance to the vehicle as well as the current trajectory of each vehicle are important considerations. In response to a vehicle in the imminent threat portion 110, countermeasure display 36 may be displayed as described above.

The second portion of threat registry 17 is a possible threat registry. In this portion of threat registry 17, a vehicle having operating characteristics that may potentially result in a collision are stored. The vehicles within possibly threat portion 112 are carefully monitored to determine whether they should be placed within the imminent threat portion 110.

The third portion of threat registry 17 is a surrounding vehicle portion. Vehicles placed within this portion of the registry are vehicles in the surrounding area or within a predetermined distance from the monitoring vehicle. These vehicles are not likely to pose a threat.

Referring now to FIG. 9, a method for operating the pre-crash sensing system is described. In step 116 the various sensors of the monitoring vehicle are read. The sensors provide an indication as to the current dynamics of the vehicle. In step 118, various vehicle data from the memory are read. In step 120 the position signal of the first vehicle from a global positioning system is obtained. In step 122 the monitoring vehicle generates an object signal and detects an object within its field of view. By detecting an object within the field of view, communication is initiated between the first vehicle or monitoring vehicle and the second vehicle, the vehicle within the field of view in step 124. A key is exchanged between the first vehicle and the second vehicle. This allows the vehicles to communicate using the key while vehicles not holding the key are excluded from communication. In a commercial environment, various vehicles may be using the same frequency to communicate and thus, by exchanging a key, only vehicles posing a threat to each other will communicate. By exchanging the key, a communication link in step 126 is formed. By using the communication link and the key, the first vehicle and the second vehicle exchange information in step 128. The information may be exchanged using the transponder or transmitter and receiver described above. The various information includes the coordinates, and may also include various other information including the braking capability, road conditions, location, time to impact and distance to collision. Thus, in step 130 the proximity of each vehicle is established. The trajectory of the first vehicle is then determined using the sensor data, vehicle data, and position data from above. By comparing the data from the first vehicle and the second vehicle and determining the proximity and trajectory, the threat of the second vehicle on the first vehicle is determined in step 134. Based on the assessment of threat, the threat registry is established in step 136 wherein the second vehicle is placed in an appropriate category. If the threat is in the third category, that is, in a surrounding vehicle portion of the threat registry in step 138, a first display may be provided to the vehicle operator in step 140. After step 140, the various sensors and surrounding vehicle information is again monitored. In step 142, if the threat is a second level threat, then a second display 144 is displayed to the vehicle operator. After step 144, the vehicle sensors are again read to update the information above. In step 142, if the threat is not the second threat level, then the threat is a first level threat in step 146. If there is a threat in the first level, system resources may be allocated to monitoring the first threat. That is, the CPU cycles of the controller may be divided so that eight to ninety percent of the CPU cycles are used to determine the vehicle likely to be a threat in 148. In step 150, countermeasures are activated in response to a vehicle in the first threat level. Two types of countermeasures may be formed and include an accident mitigation countermeasure and accident avoidance countermeasures. If the vehicle threat may be avoided, accident avoidance countermeasures take precedence. Such accident avoidance countermeasures may include controlling a steer by wire steering system or controlling the braking system of the vehicle. Of course, combinations of both and other types of accident avoidance may be performed. In step 152, a countermeasure display, such as that shown as 36 above, may be displayed.

Referring now to FIG. 10, as mentioned above, a third vehicle may be obstructed by one of the first two vehicles. Thus, it would be desirable to provide the third vehicle with information as to the threat registry of the adjacent vehicle. In step 162, each vehicle monitors to determine whether there is an adjacent vehicle. If there is no adjacent vehicle the monitoring continues. In step 162, if there is an adjacent vehicle the threat registries between the adjacent vehicles are exchanged. Thus, by having the threat registry of the adjacent vehicle, a more complete monitor of the area is formed.

As would be evident to those skilled in the art, various permutations and modifications to the above method may be performed. For example, a system in which the road condition and position of the second vehicle may be used to activate a counter-measure system may be employed. Likewise, the second vehicle position relative to the first vehicle and the road condition at the second vehicle may also be displayed to the vehicle operator. Likewise, the threat assessment may also be adjusted according to the road position.

Another embodiment of the present invention includes activating the countermeasure system in response to the braking capability of surrounding vehicles. By factoring in the braking capability of surrounding vehicles, threat assessment levels may be adjusted accordingly. Likewise, the braking capability of the first vehicle may also be used in the threat assessment level. Likewise, the displays may also be updated based upon the braking capabilities of the nearby vehicles. The braking capabilities may be determined from various tire type, size, tread, tire pressure, tire temperature, outside temperature as well as the road condition.

Advantageously, by connecting the vehicles through the network, various information may be known to drivers of other nearby vehicles. For example, the presence of black ice and other slippery conditions not readily apparent may be transmitted to other vehicles for avoidance thereof.

While particular embodiments of the invention have been shown and described, numerous variations and alternate embodiments will occur to those skilled in the art. Accordingly, it is intended that the invention be limited only in terms of the appended claims.

1. A method for operating a pre-crash sensing system for a first vehicle proximate a second vehicle a counter-measure system comprising:
generating an object detection signal over a field of view from a first vehicle;
receiving the object detection signal at the second vehicle when positioned within the field of view;
generating a response signal in response to said high frequency signal, said response signal including a key;
establishing an communication link between said first vehicle and said second vehicle using said key;
communicating a first vehicle data signal to the second vehicle using said key; and
communicating a second vehicle data signal to the second vehicle using said key.

2. A method as recited in claim 1 wherein entering the first vehicle information into the second vehicle threat registry and classifying ranking the first vehicle information within the registry.

3. A method as recited in claim 2 wherein classifying comprises classifying the first vehicle information as an imminent threat.

4. A method as recited in claim 3 further comprising allocating a system resource in response to the imminent threat.

5. A method as recited in claim 1 further comprising communicating the second vehicle threat registry to a third vehicle adjacent to the second vehicle.

6. A method as recited in claim 1 wherein communicating a first vehicle data signal comprises communicating a first position of the first vehicle.

7. A method as recited in claim 1 wherein communicating a second vehicle data signal comprises communicating a second position of the second vehicle.

8. A method as recited in claim 1 wherein communicating a first vehicle data signal comprises communicating a first heading information of the first vehicle.

9. A method as recited in claim 1 wherein communicating a second vehicle data signal comprises communicating second heading information of the second vehicle.

10. A method as recited in claim 1 wherein communicating a first vehicle data signal comprises communicating first trajectory information of the first vehicle to the second vehicle.

11. A method as recited in claim 1 further comprising classifying a threat level as a function of the first vehicle trajectory.

12. A method as recited in claim 1 further comprising activating a countermeasure system in response to the threat level.

13. A method as recited in claim 1 wherein said vehicle information comprises heading and speed.

14. A method for operating a pre-crash sensing system for a first vehicle proximate a second vehicle a counter-measure system comprising:
establishing a communication link between said first vehicle a plurality of vehicles a communication key;
communicating a vehicle data to the first vehicle from the plurality of vehicles; and
entering the vehicle data into the first vehicle threat registry;
ranking the vehicle data by vehicle within the registry in one of a plurality of classes.

15. A method as recited in claim 14 further comprising ranking some as the vehicle data as an imminent threat.

16. A method as recited in claim 14 further comprising allocating a system resource in response to the imminent threat.

17. A method as recited in claim 14 further comprising estimating a time to impact.

18. A method as recited in claim 14 further comprising activating an avoidance countermeasure when the time to impact is greater than a time threshold.

19. A method as recited in claim 14 further comprising activating an impact countermeasure when the time to impact is less than a time threshold.

20. A method as recited in claim 14 wherein generating a vehicle data signal comprises generating a vehicle type signal, a vehicle weight signal or a vehicle size signal.

21. A system for sensing a potential collision of a first vehicle with a second vehicle that transmits a second vehicle information signal, said first vehicle having a pre-crash sensing system comprising:
a threat registry;
a position sensor generating a first position signal corresponding to a position of the first vehicle;
a first sensor generating sensor signals from the first vehicle;
a receiver receiving the second vehicle position signal from the second vehicle;
a countermeasure system;
a controller coupled to the threat registry, the position sensor, the first sensor, the receiver, and said counter measure system, said controller determining a time to collision and a distance to collision in response to the second vehicle information, the first position signal and the second vehicle position, said controller determining a threat level as a function of the time to collision and the distance to collision, activating the countermeasure system in response to the threat level and storing the vehicle and threat level in the threat registry.

22. A system as recited in claim 21 wherein said controller comprises system resources, said controller allocating system resources in response to said threat level.

23. A system as recited in claim 21 wherein said counter measure system comprises avoidance countermeasures and mitigation countermeasures, said controller choosing to activate said avoidance countermeasures or mitigation countermeasures in response to said threat level.
